(19) United States
(12) Patent Application Publication
(10) Pub. No.: US 2004/0178590 A1
(43) Pub. Date: Sep. 16, 2004

(54) Child's pushchair with folding frame, integrating means to help folding

(75) Inventor: Bruno Zweideck, Cholet (FR)

Correspondence Address: Robert M. Angus, Westman, Champlin & Kelly, Suite 1600, 900 Second Avenue South, Minneapolis, MN, 55402-3319, US

(73) Assignee: AMPAFRANCE, Cholet (FR)

(21) Appl. No.: 10/777,486

(22) Filed: Feb. 12, 2004

(30) Foreign Application Priority Data
Feb. 12, 2003 (FR) FR 03 01702

(51) Int. Cl. B62B 1/00

(52) U.S. Cl. 280/42

(57) ABSTRACT

A child's pushchair has a folding frame comprising two front legs, each carrying at least one wheel. The frame is designed in such a way that, when it is being folded, the front legs approach each other. At least one of the front legs is integral with means for bearing on the ground, set in such a way that they are able to come into contact with the ground during folding, and not to touch the ground when the child's pushchair is unfolded and standing on its wheels. These bearing means can, in particular, be castors.

### FIELD OF THE INVENTION

The field of the invention is that of child welfare, and in particular folding baby carriages, or pushchairs. More precisely, the invention relates to the folding of such pushchairs.

### BACKGROUND OF THE INVENTION

Many techniques are known for folding the frame of a child's pushchair. In general, at least some of the following aims need to be met:

folding efficiency, the size of the folded pushchair being the smallest possible to facilitate its storage and transport, for example in an automobile;

simplicity of folding and unfolding manipulations, the user being able to carry out these operations in the easiest way possible;

solidity, and safety for the child transported;

simplicity and low cost of manufacturing.

Amongst the different types of frame known in prior art, there exists the so-called broken-fold type. According to this technique, when unfolded, the push rods are positioned closely along the prolongation of the front legs, and tilt relative to the latter during folding. Generally, the tilting of the push rods is directed downwards, the upper end of the push rods approaching the back wheels.

Other techniques are known in which the push rods tilt upwards, in such a way that the upper end of the push rod approaches the front wheels. In particular, this technique has been developed by the present applicant for children's pushchairs called “off-road”, that are provided with large size wheels (relative to ordinary pushchairs), and are usually equipped with inflatable tires.

According to another known technique, each push rod can slide parallel to the front shaft between a fully open position where the push rod closely prolongs the front shaft, and a folded back position where the push rod and the corresponding front shaft are arranged side by side. Each rear shaft is articulated near its upper end on the corresponding front shaft.

A further technique is known in which the frame is designed to enable folding the pushchair into a “bundle”. Such bundle folding involves the shaft legs being able to come close together so as to reduce the space taken up by the width of the pushchair, once folded. This technique can be combined with certain of the techniques mentioned above.

In particular, the present invention relates to baby carriages in which the legs come close to each other during folding.

According to this approach, folding is generally obtained, after unlocking one or several locking elements ensuring that the pushchair is blocked in its unfolded position, so as to avoid any incident involving a child still present in the pushchair, by lifting and/or standing up the pushchair, by a handlebar element or by a handle provided for this purpose near the handlebar (the handlebar being able to be formed by a single element or by two independent handles, depending on the case in question).

This operation can be relatively difficult, especially for persons who or not tall. Reduction in the width of the frame (when the legs approach each other) generally results in an augmentation of its length, in this case meaning its height.

The weight of the pushchair, even though the aim is always to reduce it, can also make this operation difficult (for example, it is not easy to lift the pushchair with one hand while holding the infant with the other hand).

Often, the above problems become amplified as the pushchair ages, as a result of wear, dirt, the appearance of play or blockage between the moving parts.

Finally, it can be noted that the users do not lift the pushchair, but keep it resting on its front wheels. This can pose two sorts of manipulation problems. First of all, the front wheels naturally have a tendency to roll, and to move away from the user, which evidently makes folding difficult, obliging the user to use force to hold back the pushchair with a foot or to lean it against a support.

On the other hand, these front wheels generally oppose movement of the legs towards one or other, because their movement is then parallel to their rotation axis. Folding therefore requires an effort to prevent these front wheels rubbing on the ground.

Thus, it can be seen that folding a child's pushchair is, in practice, often not a simple operation.

Furthermore, once folded, it is not possible to leave the pushchair upright, for example leaning against a wall, even though this would often be the most practical solution. In fact, it thus rests on its front wheels which, once again, play their role and cause the pushchair to fall. Users are therefore often obliged to lay the folded pushchair down on the ground, which is not very efficient in terms of dimensions, not ergonomic because the user has to bend over, and means that the whole of the pushchair (hammock, frame, handlebar . . . ) comes into contact with the ground which can be dirty or humid.

In particular the aim of the invention is to overcome these various disadvantages of prior art.

More precisely, the aim of the invention is to propose a baby carriage whose folding involves the front legs approaching each other, thus making folding easier.

Another aim of the invention is to provide such a baby carriage, or pushchair, that is simple to manufacture, to set up and to operate.

### SUMMARY OF THE INVENTION

These aims, together with others which will appear in the following, are obtained by means of a baby carriage with folding frame comprising two front legs, each carrying at least one wheel, the frame being designed in such a way that, when folded, the front legs approach each other. According to the invention, at least one of the front legs is equipped with means resting on the ground, mounted so as to be able to come in contact with the ground at the time of folding, and not to interfere with the ground when the baby carriage is unfolded and standing on its wheels.

In this way, simple and efficient means are obtained for blocking the pushchair or stroller, and thus to prevent it rolling away, while the kinetics of folding the frame are under way.

Preferably, bearing means are provided on each of the front legs.

Advantageously, the bearing means are set in such a way that, when they are in contact with the ground, the wheels carried by the front legs are no longer in contact with the ground.

Preferably, the bearing means are set in such a way that they come into contact with the ground when the front legs are displaced so as to reduce the angle they form with the vertical.

According to an advantageous embodiment of the invention, the bearing means are further set in such a way as to extend slightly beyond the wheels, in the horizontal plane, when the baby carriage is unfolded and standing on its wheels.

Moreover, the bearing means are preferably designed to facilitate the front legs coming together.

Thus, the bearing means advantageously comprise at least one rolling element, belonging for example to the group consisting of:

roll wheels;

castors;

balls or ball-bearings;

rollers.

The coefficient of friction opposing the approach of the front legs with pushchairs of prior art is almost completely suppressed in this way.

Therefore the legs of the pushchair can be brought together without taking the wheels off the ground, which was not possible with pushchairs of prior art.

Overall, such a pushchair thus possesses optimized ergonomics, complete folding being obtainable without bending over (avoiding unnecessary fatigue or pains in the back) and without it being necessary to lift the frame to bring the legs together, the user furthermore being able to use his or her own weight (the pushchair being blocked) to make the frame legs slide.

According to a particular embodiment of the invention, the rolling elements are set to rotate around an axle carried by a part integral with the leg, set such that the plane of rotation of the rolling element or elements is parallel to or merged with the plane extending between the legs.

Preferably, the bearing element or elements extend closely along the prolongation of the corresponding front leg.

The front legs can, in the usual way, carry a unit of two wheels. In this case, the bearing elements are advantageously set between the two wheels of at least one of the units.

The wheel or wheels carried by the front legs are, advantageously, directional wheels. In this case the child's pushchair preferably includes means for locking the wheels in a fixed position parallel to the principal axis of the pushchair.

Advantageously, the child's pushchair then comprises means for keeping the wheels in a fixed position parallel to the principal axis of the pushchair during folding.

In particular, they can act on the locking means of the wheels and/or comprise return means.

According to another advantageous embodiment of the invention, means can be provided for bringing the bearing means into a working position during folding, and for retracting the bearing means when the child's pushchair is unfolded.

### BRIEF DESCRIPTION OF THE DRAWINGS

Other features and advantages of the invention will become clearer by reading the following description of a preferred embodiment of the invention, given as an illustrative but non-limiting example, and the attached diagrams amongst which:

FIG. 1 is a view in perspective of a pushchair's front shaft carrying the bearing means according to the invention, the pushchair being unfolded;

FIGS. 2 and 3 respectively are views in perspective and from the front of the front shaft of the pushchair of FIG. 1, the pushchair being folded.

### DETAILED DESCRIPTION OF THE PREFERRED EMBODIMENTS

As has been mentioned above, the invention is based on a principal consisting of providing bearing means allowing the pushchair to be blocked during folding, especially in order to transmit an applied force more easily to a determined place in order to obtain folding (for example, on the pushchair, to engage the frame's sliding elements), without the pushchair moving by rolling on its front wheels.

According to the particular embodiment described in more detail below, these bearing elements are formed by rolling elements simplifying folding the pushchair into a bundle.

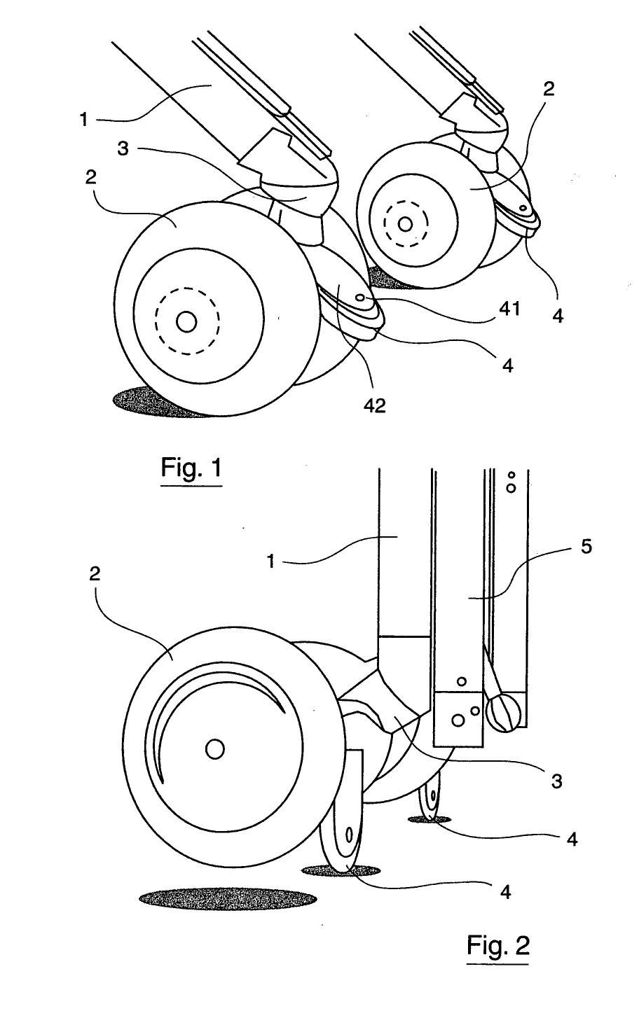

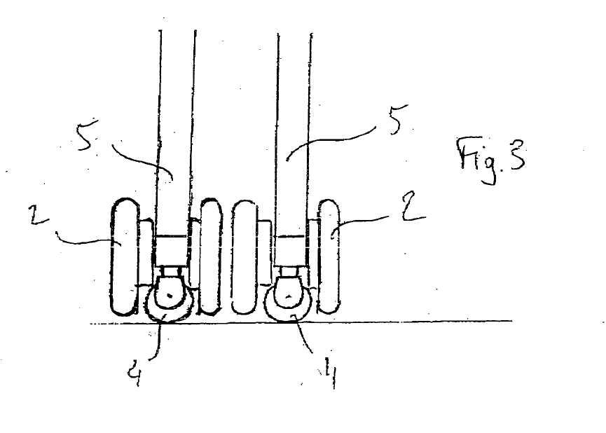

FIGS. 1 and 2 show a portion (corresponding to the front wheels) of a pushchair equipped with a folding frame. During a folding maneuver, the following operations are carried out:

bring the back shaft close to the front shaft;

slide the push rods on the corresponding shafts;

bring the shafts together transversally, by a pushing action on the guide handles, or the handlebar, after the locking means keeping the pushchair in its open position have been unlocked.

FIG. 1 shows the position taken by the legs 1 of the front shaft when the frame is unfolded.

According to the present embodiment of the invention, each leg 1 of the front shaft is equipped with two wheels 2 carried by a wheel unit 3 set to rotate freely at the end of the corresponding leg.

According to the invention, the legs 1 are each provided with a castor 4, whose prime function is to form a means for bearing on the ground.

This castor 4 is carried by a support set on the leg 1, in the prolongation of the latter.

To fold the pushchair frame (and in particular to make the push rod 5 slide on the leg 1), the pushchair is stood up in the usual way. Then the pushchair is tilted slightly forwards (reducing the angle formed by the legs and the vertical), thus bringing the castors 4 into contact with the ground. As can be seen in FIG. 2, the front wheels 2 are then no longer in contact with the ground and therefore cannot make the pushchair move forward.

Next, while maintaining the pushchair in this position, (the appropriate security elements having been unlocked), one can push on the push rod 5 to obtain folding (by making it slide on the leg 1, in the embodiment described) and to bring the two legs close to one another, until the frame is brought into a position such as that shown in FIG. 3.

The castors 4 simplify this approach which, in prior art, was only possible through the frame mechanism.

As FIG. 1 clearly shows, the rotation axle 41 of the castors is carried by two plates 42 set on the corresponding wheel unit 3.

It is to be noted that this assembly is envisaged in such a way that each castor 4 extends between the two wheels 2 of the corresponding leg.

Furthermore, the setting of the castors 4 is envisaged such that their rotational plane is parallel to the plane extending between the legs.

Thus, the folding maneuver can be carried out without effort, consisting of bringing the legs 1 close to each other, by proceeding as follows: the front shaft is tilted forwards, until the 4 castors come into contact with the ground through the intermediary of their rolling surface. In this position, the legs 1 are closely vertical as shown by FIGS. 2 and 3, and rest on the ground solely through the intermediary of the castors 4. In other words, the wheels 2 are lifted up relative to the ground, and thus are not in contact with it.

Therefore the wheels 2 do not oppose the legs 1 being brought close to each other, this displacement being guided and facilitated by making the castors 4 roll towards each other on the ground.

Moreover, the position of the frame shown in FIGS. 2 and 3 can also correspond to a storage position, the pushchair being either balanced on the castors 4 or leaning against a wall, for example.

When leaning against a wall, it is understood that the castors 4 are oriented in such a way that they oppose movement of the pushchair under the effect of its own weight, in contrast to the possible risk of movement in the case where the wheels 2 remain on the ground.

Generally speaking, the front wheels or wheel units are directional, meaning free to rotate. In order to obtain efficient folding, and in particular if the castor 4 is integral with the wheel unit, the latter must be aligned with the principal axis of the child's pushchair.

For certain types of terrain, locking means are often provided for the directional wheels. Thus it can be envisaged that the unlocking of the pushchair anti-folding security features, when the time comes to fold it, act on the locking means of the wheels, to bring them back to the correct direction.

According to one method, possibly combined with the first, the front wheels or wheel units can be equipped with return means, tending to bring the wheel direction back along the principal axis of the pushchair. These return means could be arranged so as to bring the wheels into this position as soon as they no longer touch the ground.

Furthermore, it is to be noted that several variants of embodiments of the invention can be envisaged. In particular, the castors can be replaced by any other rolling means, such as several rollers or ball-bearings, a spherical ball, a roll wheel etc.

In a simplified version, it can also involve a fixed element. Preferably, in this case, it will have a configuration (both shape and material) that simplifies folding.

It also possible to envisage that bearing means are only applied on a single leg, or that the bearing means differ from one leg to another.

Although the present invention has been described with reference to preferred embodiments, workers skilled in the art will recognize that changes may be made in form and detail without departing from the spirit and scope of the invention.

What is claimed is:

1. A pushchair with a folding frame comprising two front legs, each carrying at least one wheel, the frame being designed such that, during folding, the front legs approach each other,
characterized in that at least one of the front legs is equipped with means for bearing on the ground, set in such a way as to come into contact with the ground during folding, and not to touch the ground when the pushchair is unfolded and standing on its wheels.

2. The pushchair according to claim 1, characterized by the inclusion of bearing means on each of the front legs.

3. The pushchair according to claim 1, characterized in that the bearing means are mounted in such a way that, when they are in contact with the ground, the wheels carried by the front legs are no longer in contact with the ground.

4. The pushchair according to claim 1, characterized in that the bearing means are set in such a way that they come into contact with the ground when the front legs are displaced so as to reduce the angle they form with the vertical.

5. The pushchair according to claim 1, characterized in that the bearing means are set in such a way that they extend slightly beyond the wheels, in the horizontal plane, when the pushchair is unfolded and standing on its wheels.

6. The pushchair according to claim 1, characterized in that the bearing means are designed so that they simplify bringing the front legs together.

7. The pushchair according to claim 6, characterized in that the bearing means comprise at least one rolling element.

8. The pushchair according to claim 7, characterized in that the rolling element or elements include at least one element belonging to the group consisting of:
roll wheels;
castors;
balls or ball-bearings;
rollers.

9. The pushchair according to claim 4, characterized in that the rolling elements are set so as to rotate around an axle carried by an integral part of the leg, set in such a way that the plane of rotation of the rolling element or elements is parallel to or merged with the plane extending between the legs.

10. The pushchair according to claim 1, characterized in that the bearing element or elements extend closely along the prolongation of the corresponding front leg.

11. The pushchair according to claim 1, characterized in that each of the front legs carries a unit of two wheels, and in that the bearing elements are set between the two wheels of at least one of the units.

12. The pushchair according to claim 1, characterized in that the wheel or wheels carried by the front legs (1) are directional wheels.

13. The pushchair according to claim 12, characterized in that it comprises means for locking the wheels in a fixed position parallel to the principal axis of the pushchair.

14. The pushchair according to claim 12, characterized in that it comprises means for bringing back the wheels to a fixed position parallel to the principal axis of the pushchair, during folding.

15. The pushchair according to claim 14, characterized in that the means for bringing back the wheels act on the locking means of the wheels.

16. The pushchair according to claim 14, characterized in that the means for bringing back the wheels comprise return means.

17. The pushchair according to claim 1, characterized by the inclusion of means for bringing the bearing means into working position during folding, and for retracting the bearing means when the pushchair is unfolded.

18. The pushchair according to claim 2, characterized in that the bearing means are mounted in such a way that, when they are in contact with the ground, the wheels carried by the front legs are no longer in contact with the ground.

19. The pushchair according to claim 2, characterized in that the bearing means are set in such a way that they come into contact with the ground when the front legs are displaced so as to reduce the angle they form with the vertical.

20. The pushchair according to claim 2, characterized in that the bearing means are set in such a way that they extend slightly beyond the wheels, in the horizontal plane, when the pushchair is unfolded and standing on its wheels.
